(19) United States
(12) Patent Application Publication
(10) Pub. No.: US 2025/0190771 A1
(43) Pub. Date: Jun. 12, 2025

(54) MEMORY RECALL FOR NEURAL NETWORKS

(71) Applicant: INTERNATIONAL BUSINESS MACHINES CORPORATION, ARMONK, NY (US)

(72) Inventors: JOHN S. WERNER, FISHKILL, NY (US); ANDREW C. M. HICKS, HIGHLAND, NY (US)

(21) Appl. No.: 18/530,526

(22) Filed: Dec. 6, 2023

(51) Int. Cl. G06N 3/063

(52) U.S. Cl. CPC G06N 3/063

(57) ABSTRACT

Memory recall for neural networks, including: receiving one or more inputs for a neural network; determining if an entry corresponding to the one or more inputs is stored in a memory lookup table for the neural network, wherein the memory lookup table comprises a plurality of entries each associating a respective neural network input with a corresponding output generated by a version of the neural network; responsive to the entry being stored in the memory lookup table, providing the corresponding output for the entry; and responsive to the entry not being stored in the memory lookup table, providing an output by processing the one or more inputs by the neural network to generate the output.

### BACKGROUND

The present disclosure relates to methods, apparatus, and products for memory recall for neural networks.

### SUMMARY

According to embodiments of the present disclosure, various methods, apparatus and products for memory recall for neural networks are described herein. In some aspects, memory recall for neural networks includes receiving one or more inputs for a neural network; determining if an entry corresponding to the one or more inputs is stored in a memory lookup table for the neural network, wherein the memory lookup table comprises a plurality of entries each associating a respective neural network input with a corresponding output generated by a version of the neural network; and responsive to the entry being stored in the memory lookup table, providing the corresponding output for the entry; and responsive to the entry not being stored in the memory lookup table, providing an output by processing the one or more inputs by the neural network to generate the output. This allows for output generated by a neural network with high confidence to be recalled, preventing low confidence output due to drift and reducing the overall computational overhead used by the neural network.

In some aspects, determining if an entry corresponding to the one or more inputs is stored in the memory lookup table includes generating a signature for the one or more inputs by processing the one or more inputs by the neural network until a memory check layer of the neural network is reached; and comparing the signature for the one or more inputs to the memory lookup table. This allows for the memory lookup table to be referenced using sequences of activated neurons and their respective confidence levels to identify previously generated output of high confidence.

In some aspects, the method may include flagging the one or more inputs for potential storage in the memory lookup table in response to an output threshold for the one or more inputs being satisfied. This allows for inputs with high confidence outputs to be flagged for future analysis and evaluation as to whether they should be included in the memory lookup table.

In some aspects, an apparatus may include a processing device; and memory operatively coupled to the processing device, wherein the memory stores computer program instructions that, when executed, cause the processing device to receive one or more inputs for a neural network; determine if an entry corresponding to the one or more inputs is stored in a memory lookup table for the neural network, wherein the memory lookup table comprises a plurality of entries each associating a respective neural network input with a corresponding output generated by a version of the neural network; and responsive to the entry being stored in the memory lookup table, provide the corresponding output for the entry; and responsive to the entry not being stored in the memory lookup table, provide an output by processing the one or more inputs by the neural network to generate the output. This allows for output generated by a neural network with high confidence to be recalled, preventing low confidence output due to drift and reducing the overall computational overhead used by the neural network.

In some aspects, determining if an entry corresponding to the one or more inputs is stored in the memory lookup table includes generating a signature for the one or more inputs by processing the one or more inputs by the neural network until a memory check layer of the neural network is reached; and comparing the signature for the one or more inputs to the memory lookup table. This allows for the memory lookup table to be referenced using sequences of activated neurons and their respective confidence levels to identify previously generated output of high confidence.

In some aspects, the computer program instructions, when executed, cause the processing device to flag the one or more inputs for potential storage in the memory lookup table in response to an output threshold for the one or more inputs being satisfied. This allows for inputs with high confidence outputs to be flagged for future analysis and evaluation as to whether they should be included in the memory lookup table.

In some aspects, a computer program product comprising a computer readable storage medium may store computer program instructions that, when executed, receive one or more inputs for a neural network; determine if an entry corresponding to the one or more inputs is stored in a memory lookup table for the neural network, wherein the memory lookup table comprises a plurality of entries each associating a respective neural network input with a corresponding output generated by a version of the neural network; and responsive to the entry being stored in the memory lookup table, provide the corresponding output for the entry; and responsive to the entry not being stored in the memory lookup table, provide an output by processing the one or more inputs by the neural network to generate the output. This allows for output generated by a neural network with high confidence to be recalled, preventing low confidence output due to drift and reducing the overall computational overhead used by the neural network.

In some aspects, determining if an entry corresponding to the one or more inputs is stored in the memory lookup table includes generating a signature for the one or more inputs by processing the one or more inputs by the neural network until a memory check layer of the neural network is reached; and comparing the signature for the one or more inputs to the memory lookup table. This allows for the memory lookup table to be referenced using sequences of activated neurons and their respective confidence levels to identify previously generated output of high confidence.

In some aspects, the computer program instructions, when executed, flag the one or more inputs for potential storage in the memory lookup table in response to an output threshold for the one or more inputs being satisfied. This allows for inputs with high confidence outputs to be flagged for future analysis and evaluation as to whether they should be included in the memory lookup table.

### BRIEF DESCRIPTION OF THE DRAWINGS

FIG. 1 sets forth a block diagram of an example computing environment for memory recall for neural networks in accordance with some embodiments of the present disclosure.

FIG. 2 sets forth an example flow diagram for memory recall for neural networks in accordance with some embodiments of the present disclosure.

FIG. 3 sets forth another example flow diagram for memory recall for neural networks in accordance with some embodiments of the present disclosure.

FIG. 4 sets forth a flow chart of an example method for memory recall for neural networks in accordance with some embodiments of the present disclosure.

FIG. 5 sets forth a flow chart of another example method for memory recall for neural networks in accordance with some embodiments of the present disclosure.

FIG. 6 sets forth a flow chart of another example method for memory recall for neural networks in accordance with some embodiments of the present disclosure.

FIG. 7 sets forth a flow chart of another example method for memory recall for neural networks in accordance with some embodiments of the present disclosure.

FIG. 8 sets forth a flow chart of another example method for memory recall for neural networks in accordance with some embodiments of the present disclosure.

FIG. 9 sets forth a flow chart of another example method for memory recall for neural networks in accordance with some embodiments of the present disclosure.

FIG. 10 sets forth a flow chart of another example method for memory recall for neural networks in accordance with some embodiments of the present disclosure.

### DETAILED DESCRIPTION

Artificial intelligence models such as neural networks are trained to recognize patterns and become efficient at making predictions are decisions. Such models may be continuously (e.g., repeatedly) trained over time using additional training data such as inputs previously provided to and outputs previously generated by the model. A model can drift if the input data to the model, and thus the training data for the model, significantly changes over time. For example, a visual recognition module such as those used in autonomous vehicles may, through reinforcement learning, become efficient in recognizing items in a first environment in which it operating, such as in a city. If the vehicle is later used in a second, different environment such as the countryside, the reinforcement learning will alter the model to adapt to its new environment and better recognize items in the countryside. Should the vehicle return to the city environment, the visual recognition system may have difficulty in recognizing items that were previously efficiently recognized. As another example, large language models (LLMs) may train based on an influx of information on a specific, virally popular topic, thereby become more efficient at providing answers related to that topic. The LLM may then adapt to new questions over time after the viral influx related to that topic is gone. In the future, the LLM may not produce results related to the previously viral topic with the same level of confidence. Accordingly, it may be beneficial to provide mechanisms for neural networks or other models to recall information previously output with high degrees of confidence should the model drift over time due to continuous retraining.

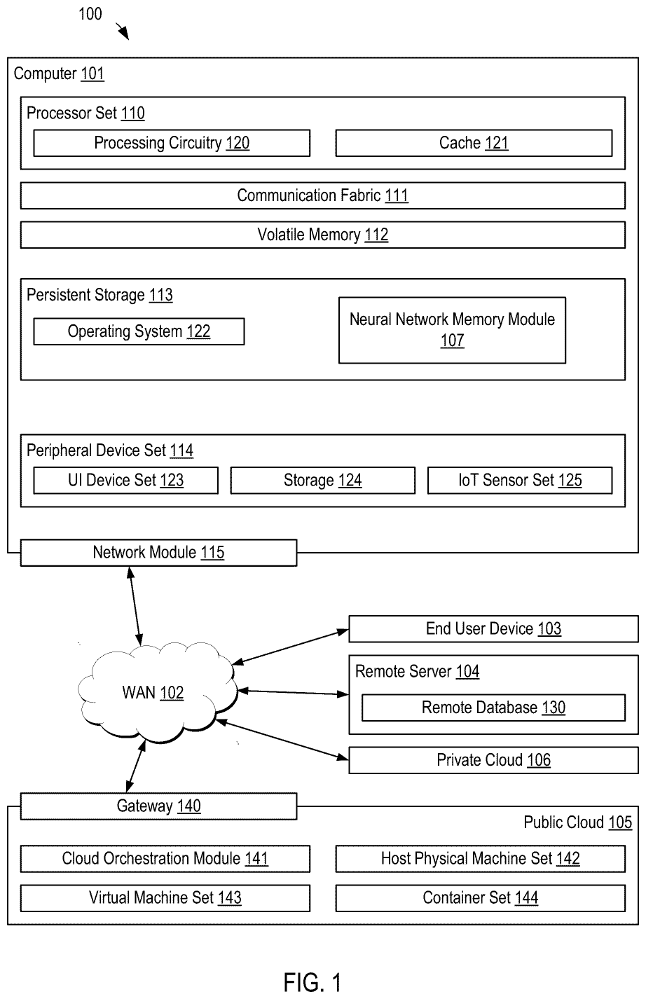

With reference now to FIG. 1, shown is an example computing environment according to aspects of the present disclosure. Computing environment 100 contains an example of an environment for the execution of at least some of the computer code involved in performing the various methods described herein, such as the neural network memory module 107. In addition to the neural network memory module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

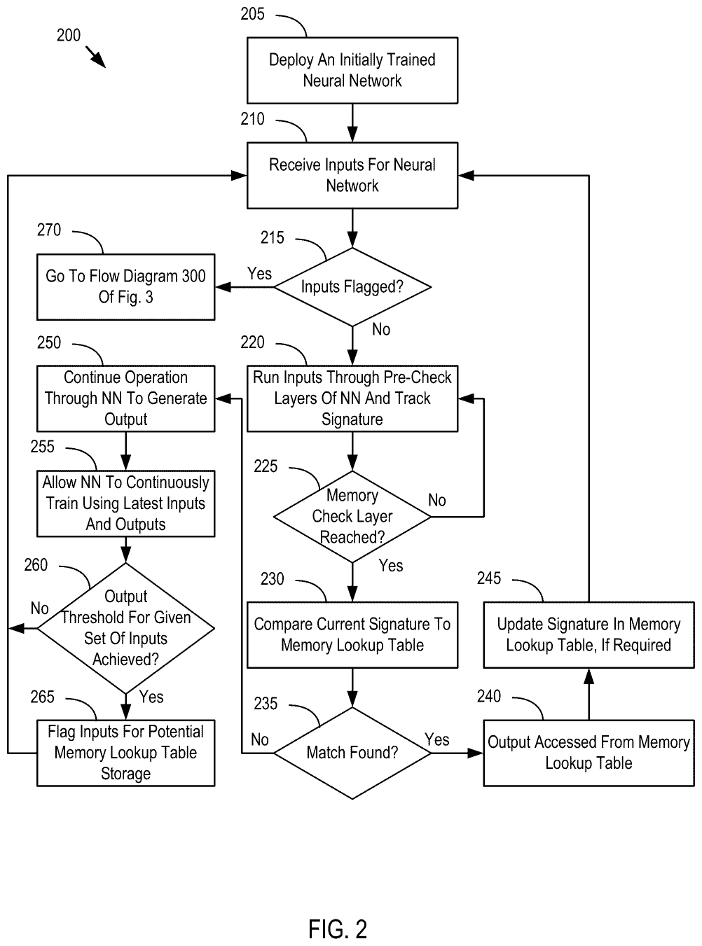

FIG. 2 sets forth a flow diagram 200 describing approaches for memory recall for neural networks in accordance with some embodiments of the present disclosure. Beginning at block 205, an initially trained neural network is deployed. Although the approaches set forth herein are described in the context of a neural network, one skilled in the art will appreciate that the approaches set forth herein may be applied to any type of trained model as can be appreciated. For example, the approaches set forth herein may be applied to neural networks (e.g., feed-forward neural networks, natural language processing models, LLMs, and the like), regression models, deep learning models, support vector machines (SVMs), random forests, other generative artificial intelligence models, and/or other machine learning models as can be appreciated.

At block 210, inputs for the neural network are received. The inputs are some input data to be provided to the neural network for processing to generate some output. The inputs for the neural network may be received from a variety of sources. For example, the inputs for the neural network may be generated by some process or service executed within the same device or computing environment as the neural network. As another example, the inputs may be received from a remotely disposed computing device via a network. The inputs may include any type of data as can be appreciated, such as text data, image data, video data, and the like.

At block 215 it is determined whether the inputs have been flagged for potential storage in a memory lookup table, to be described in further detail below. For example, in some embodiments, a table or data structure (e.g., a flag table) may store particular inputs or identifiers thereof, such as hash values of particular inputs, such that their inclusion in this flag table indicates that the inputs are flagged. If not, the process advances to block 220 where the inputs are run through pre-check layers of the neural network. Pre-check layers of the neural network are one or more layers of the neural network prior to a memory check layer where the signature of the inputs is compared to the memory lookup table. Put differently, the pre-check layers are those layers of the neural network that will always be run or applied to some input regardless of whether an output for that input has a corresponding output stored in the memory lookup table.

In some embodiments, the memory check layer may be the first layer of the neural network, meaning that the memory lookup table may be accessed or queried without any processing by the neural network. In some embodiments, the memory check layer may be any other layer within the neural network. In some embodiments, the neural network may include multiple memory check layers. In such embodiments, the current signature for the inputs may be used to query the memory lookup table at each encountered memory check layer. One skilled in the art will appreciate that neural networks with fewer memory check layers may be more efficient when the inputs must be fully processed by the neural network to generate an output (e.g., where no entry is stored in the memory lookup table). However, neural networks with more check layers may yield more recall from the memory lookup table and produce faster output generation for those input sets. In some embodiments, the optimal or preferred layer for the last (or only) memory check layer may be calculated based on a number of prior checks (e.g., queries to the memory lookup table) where there is no computational benefit to performing checks after that layer (e.g., based on the relative computational burden of performing a memory check lookup compared to processing a neural network layer).

At block 225 it is determined if the memory check layer has been reached. If not, the process returns to block 220 to continue to the next layer of the neural network. If so, the process advances to block 230 where the current signature for the inputs is used to query a memory lookup table. The signature for a given input includes the activated neurons and output accuracy prediction (e.g., an output confidence score or percentage) at each layer of the pre-check layers up to the current memory check layer. The memory lookup table is a database, table, or other data structure that associates particular neural network inputs and their respective outputs. Particularly, each entry in the memory lookup table may associate some input previously provided to the neural network, including to previous versions of the neural network, and their respective output. As described herein, a version of a neural network is an instance of that neural network trained on some corpus of training data. Thus, as the neural network is continuously or repeatedly retrained, each retraining of the neural network produces a different version of the neural network.

Each entry in the memory lookup table includes some value or identifier of a particular input to the neural network and an output generated by some version of the neural network based on that particular input. In some embodiments, the value of identifier of a particular input may include the signature for that input generated when processing the input by the neural network. Accordingly, in some embodiments, the memory lookup table may be indexed or referenced using the signature of an input. For example, in some embodiments, the signature of an input may be hashed or otherwise processed to generate an index value for accessing the memory lookup table. In some embodiments, the memory lookup table may be traversed to compare the signatures in stored entries to the signature of the current input. In some embodiments, a signature for an input may be considered a match for the signature of an entry in the memory lookup table where each point in the sequence of the signature of the input falls within some range or standard deviation of the corresponding points in the signature of the entry in the memory lookup table (e.g., a “tolerance range”). In some embodiments, the signatures in the memory lookup table may correspond to different levels or layers than the signature of the input. For example, depending on when the entry in the memory lookup table was created, the signature in the memory lookup table entry may end at a later or earlier layer than the signature of the input. In such embodiments, the signature of the memory lookup table and/or the input may be truncated such that they terminate at the same layer, after which they may be compared as described above. In some embodiments, rather than use a signature, a memory neural network may instead be used. A memory neural network is a portion of a previous version of the neural network up to a particular check layer. For example, a memory neural network may be used where the performance of a particular set of inputs was above a high threshold, such as ninety-eight-percent accurate.

At block 235 it is determined whether a match for the signature of the input was found in the memory lookup table. If a match is found, at block 240, the corresponding entry in the memory lookup table is accessed. The output stored in that entry is then provided as a response to the received inputs. In some embodiments, the process advances to block 245 where the signature for the matching entry in the memory lookup table is updated, if required. For example, if the signatures for inputs matching the entry are drifting towards one end or the other of the tolerance range, the model may be experiencing some drift but is still accurate at producing outputs. Accordingly, the signature of the entry in the memory lookup table may be adjusted so that newer input signatures will not fall outside the tolerance range of the entry in the memory lookup table. After performing any signature updates the process advances back to block 210 where another input for the neural network is received.

Returning back to block 235, if no match was found in the memory lookup table, the process advances to block 250 where the remaining layers of the neural network after the memory check layer are used to process the inputs in order to generate some output. In some embodiments, rather than being performed prior to processing the inputs by the pre-check layers at block 215, determining whether the inputs are flagged may instead be performed prior to block 250 should no match be found. In such embodiments, the flag table may instead store the signatures of flagged inputs such that the now-generated signature may be used to query the flag table.

At block 255, the neural network may be continuously retrained using the latest inputs and outputs. For example, in some embodiments, the neural network may be retrained each time after an output is generated by the neural network using some input. In some embodiments, the neural network may be retrained every N iterations of the neural network (e.g., after producing N outputs by the neural network), at a predefined interval using input and output generated during that interval, or in response to other conditions as can be appreciated. The neural network may be retrained using supervised learning, unsupervised learning, semi-supervised learning, or any other training approach as can be appreciated.

The process then advances to block 260 where it is determined if an output threshold has been achieved for a given input (e.g., the input processed during the most recent iteration of the neural network). The output threshold is satisfied where the confidence level of the output for the given input exceeds some threshold (e.g., ninety-eight-percent confidence or greater). In some embodiments, the output threshold may be satisfied where the output confidence level for a given input is exceeded for a threshold number of iterations (e.g., N outputs for the given input having confidence levels above the output threshold) or a threshold amount of time (e.g., outputs for the given input having confidence above the output threshold for at least one month).

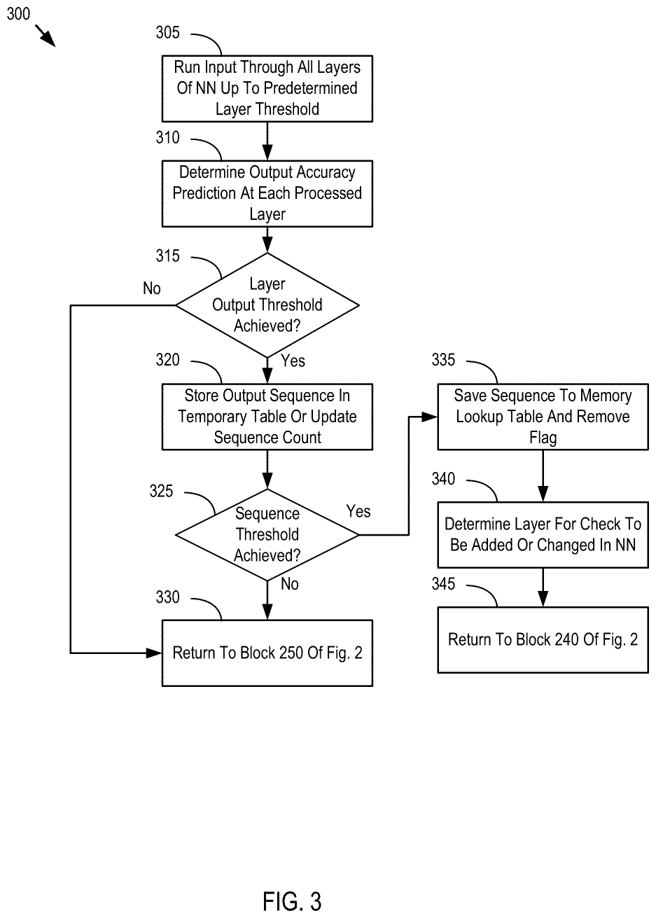

If the output threshold is satisfied, at block 265 the given input is flagged for potential storage (e.g., inclusion) in the memory lookup table. For example, an entry for the inputs may be added to a flag table as described above, with the entry including the inputs, a hash value based on the inputs, a signature for the inputs, or other information as can be appreciated depending on the particular implementation of the flag table. After flagging the input in block 265 or, if at block 260 the output threshold was not satisfied, the process returns to block 210 where another input may be received by the neural network. Turning back to block 215, for the inputs to the neural network that had previously been flagged for potential storage in the memory lookup table, the process advances to block 270 where the process described in the flow diagram 300 of FIG. 3 is performed.

Accordingly, FIG. 3 sets forth a flow diagram 300 for determining if a flagged input should have an entry added in the memory lookup table. At block 305, the input is run through all layers of the neural network up to a predetermined layer threshold. In some embodiments, the layer threshold may be a layer where it may be no longer computationally beneficial to query the memory lookup table instead of fully process the input using the neural network. In other words, the layer threshold may be a layer where the computational burden of querying the memory lookup table exceeds the computational burden of processing the input using the remaining layers. In some embodiments, the layer threshold may include a layer where a check layer has been added. In some embodiments, the layer threshold may be a layer after some other check layer to allow for moving the check layer or adding new check layers to the neural network. In some embodiments, the layer threshold may be after the final layer of the neural network such that the input is fully processed.

At block 310 the output accuracy prediction at each layer that processed the input (e.g., each layer up to the layer threshold) is calculated. At block 315 it is determined if the layer output threshold is achieved. Here, the layer output threshold is achieved if the output accuracy prediction for each layer exceeds some threshold. In some embodiments, this threshold may be different (e.g., greater than or lower) than the threshold described above initially used to flag the inputs. In some embodiments, this threshold may be configured based on particular design or engineering considerations.

If the layer output threshold is achieved, the process advances to block 320 where the output sequence (e.g., the activated neurons and the corresponding output accuracy predictions for each layer used to process the flagged input) is stored in a temporary table. Where an entry exists in this temporary table, a count in the associated entry is incremented. In some embodiments, the count may only be incremented where the output for the given sequence matches the output from fully running the inputs through the neural network and has a similar sequence up to a certain layer of the neural network. In some embodiments, rather than using a temporary table, the new data generated in flow diagram is added to entries in the flag table previously mentioned in the description of flow diagram 200.

At block 325 it is determined whether a sequence threshold has been achieved for the flagged inputs. A sequence threshold is a threshold to which the count in the temporary table is compared. Accordingly, the sequence threshold for the flagged inputs is satisfied when the count of the entry in the temporary table exceeds some threshold. If not, the process moves to block 330, thereby returning to block 250 of FIG. 2. If the sequence threshold has been satisfied, at block 335, an entry is created in the memory lookup table for the flagged input using the output sequence for the flagged input as described above. The new entry in the memory lookup table stores an output for the flagged inputs that may be retrieved from the memory lookup table when the input is subsequently encountered by the neural network. In some embodiments, as the inputs have been processed by the neural network up to a memory check layer, this output may be generated by stopping processing of the neural network or skipping layers up to the output layer. In some embodiments, an output may be stored in the flag table when the input is initially flagged. That output in the flag table entry may be loaded and stored in the new entry of the memory lookup table. In some embodiments, where a count was increased only in response to the output from a sequence matching the output from running through the entire neural network, the output generated by running the inputs through the entire neural network may be used in the new memory lookup table entry. The flag indicating the inputs as potentially being stored in the memory lookup table is then removed (e.g., by removing an entry in the flag table).

A memory check layer for the neural network is then determined at block 340. This may include determining whether a memory check layer should be added or whether an existing memory check layer should be moved. In some embodiments, a current version of the neural network up to where the layer output threshold was achieved (e.g., the layers of the neural network that processed the previously flagged input) may be saved. In some embodiments, where the layer output threshold was achieved at a layer after current memory check layers, an additional layer can be added or an existing layer may be shifted. In some embodiments, where the layer output threshold was achieved at a layer before current memory check layers an additional layer can be added or the signature can be tracked up to the current memory check layer even if not required for the specific signature. In some embodiments, memory check layers may be shifted based on an analysis of the entries within the memory lookup table. For example, memory check layers may be shifted or established at the highest layer in a memory lookup table entry signature, an average layer at which a memory lookup table entry signature ends, and the like. The process then moves to block 345, returning to block 240 of FIG. 2 whereby the output value is accessed from the newly created entry in the memory lookup table.

The approaches described above allow for a memory lookup table to be maintained for a particular neural network. An entry may be created in the memory lookup table where the neural network provides output for some input with high confidence. Should future versions of the neural network encounter similar inputs as indicated by the signature of the input, the output for that input may be loaded from the memory lookup table instead of fully processing the input to generate some output. This improves computational efficiency by eliminating the need to fully process some inputs. Moreover, this eliminates the neural network from providing lower-confidence output for inputs for which high-confidence outputs had previously been generated due to drift.

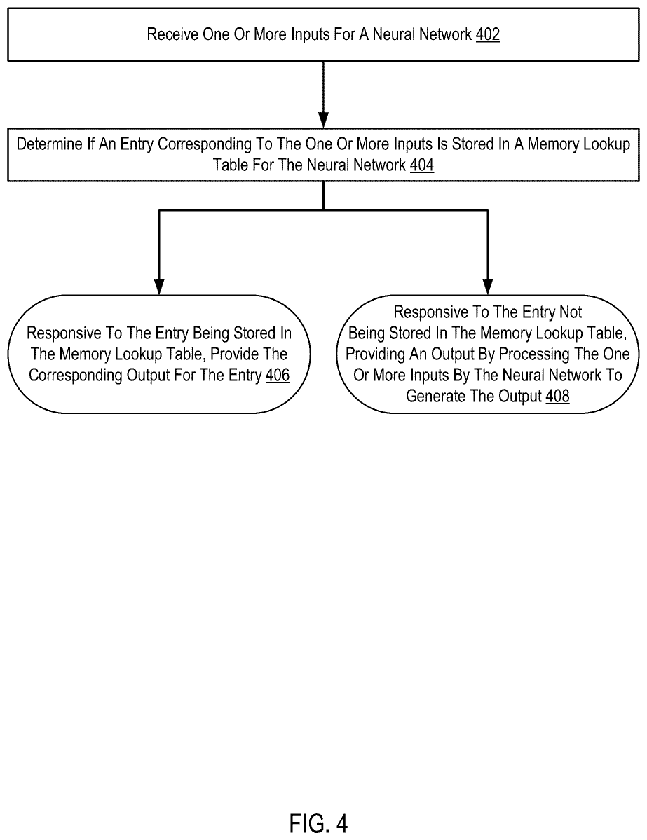

For further explanation, FIG. 4 sets forth a flowchart of an example method of memory recall for neural networks in accordance with some embodiments of the present disclosure. The method of FIG. 4 may be performed, for example, by the neural network memory module 107 described above. The method of FIG. 4 includes receiving 402 one or more inputs for a neural network. As is described above, the neural network may include a variety of neural networks as can be appreciated while the one or more inputs may include any type of data that may be analyzed or otherwise used by a neural network to generate some output. Particularly, the neural network may include a neural network that is continuously or otherwise repeatedly retrained, thereby generating new versions of the neural network over time. The method of FIG. 4 also includes determining 404 if an entry corresponding to the one or more inputs is stored in a memory lookup table for the neural network.

A memory lookup table is a database, table, or other data structure that associates inputs previously provided to the neural network (e.g., some version of the neural network) with the corresponding output previously generated by the neural network. For example, in some embodiments, each entry of the memory lookup table may include, and therefore be indexed using, an identifier for an input. Such an identifier may include a signature generated by at least partially processing the input using the neural network, to be described in further detail below. Accordingly, in some embodiments, determining 404 if an entry corresponding to the one or more inputs is stored in the memory lookup table for the neural network may include determine if an entry in the memory lookup table has an input identifier (e.g., a signature) matching that of the received 402 one or more inputs.

If an entry is stored, the method of FIG. 4 includes providing 406, responsive to the entry being stored in the memory lookup table, the corresponding output for the entry. For example, the output value in the matching entry may be accessed and provided to a source of the received 402 one or more inputs or to another entity as can be appreciated. Thus, an output for the received 402 one or more inputs may be provided without the need to fully process these inputs using the neural network.

If no entry in the memory lookup table is found, the method of FIG. 4 includes providing 408, responsive to the entry not being stored in the memory lookup table, an output by processing the one or more inputs by the neural network to generate the output. Thus, if no entry is found, the inputs must be fully processed in order to generate some output. As will be described in further detail below, after processing the received 402 inputs to generate the output, the received outputs may be evaluated and flagged for potential inclusion in the memory lookup table, thereby saving on future computational burden associated with processing that input by the neural network.

In some embodiments, the memory lookup table or some other metadata or data structure may associate particular input identifiers (e.g., input signatures as will be described below) with a version of the neural network used to generate the high confidence output for the corresponding input. For example, a previous version of a neural network or a portion thereof may be saved. In some embodiments, the identifier (e.g., signature) for a given input may be compared to the identifiers for these saved neural networks. In response to a match, rather than loading a previously generated output, the saved version of the neural network may be loaded and the received 402 one or more inputs are provided to the loaded neural network to generate some output.

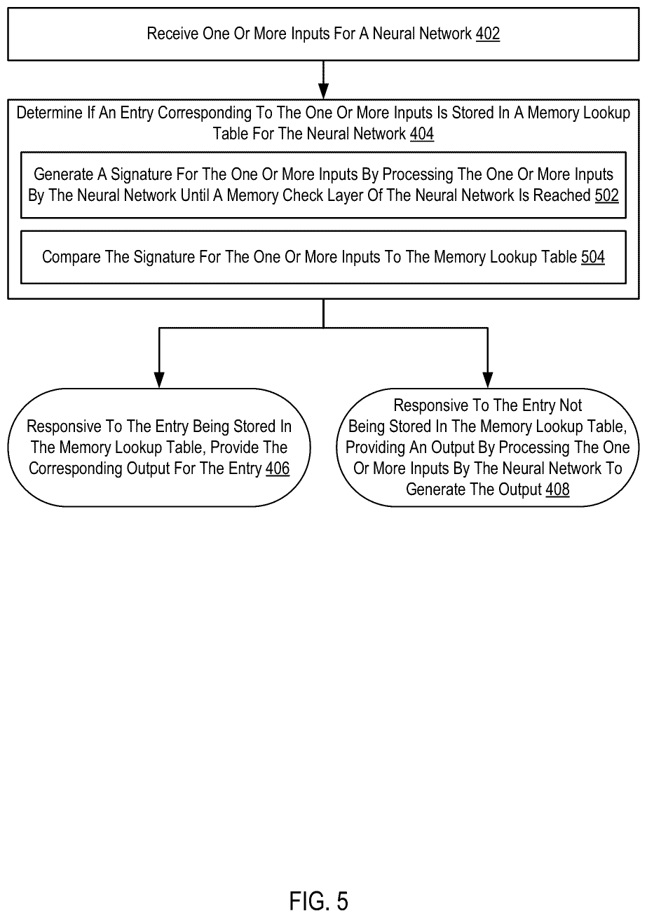

For further explanation, FIG. 5 sets forth a flowchart of an example method of memory recall for neural networks in accordance with some embodiments of the present disclosure. The method of FIG. 5 is similar to FIG. 4 in that the method of FIG. 5 also includes: receiving 402 one or more inputs for a neural network; determining 404 if an entry corresponding to the one or more inputs is stored in a memory lookup table for the neural network; providing 406, responsive to the entry being stored in the memory lookup table, the corresponding output for the entry; and providing 408, responsive to the entry not being stored in the memory lookup table, an output by processing the one or more inputs by the neural network to generate the output.

The method of FIG. 5 differs from FIG. 4 in that determining 404 if an entry corresponding to the one or more inputs is stored in a memory lookup table for the neural network includes generating 404 a signature for the one or more inputs by processing the one or more inputs by the neural network until a memory check layer of the neural network is reached. A memory check layer is a designated layer of the neural network that, once reached, causes the memory lookup table to be queried using the generated signature. If no match is found in the memory lookup table, processing of the inputs by the neural network continues from the memory check layer. A signature for the one or more inputs is data that describes the activated neurons at each layer of the neural network and the corresponding output accuracy prediction (e.g., confidence score) for each layer of the neural network used to process the inputs thus far (e.g., up to the memory check layer).

The method of FIG. 5 further differs from FIG. 4 in that determining 404 if an entry corresponding to the one or more inputs is stored in a memory lookup table for the neural network includes comparing 504 the signature for the one or more inputs to the memory lookup table. For example, the signature for the one or more inputs may be compared to signature values for the entries in the memory lookup table. Comparing the signature for the one or more inputs to the signature values for the entries in the memory lookup table may be performed by iterating through the memory lookup table or searching the memory lookup table according to some search algorithm depending on the organizational structure of the memory lookup table. The signature for the one or more inputs (e.g., the input signature) may be deemed to match the signature in an entry in the memory lookup table (e.g., the entry signature) where each value of the input signature matches or falls within some range or standard deviation of the corresponding value of the entry signature (e.g., a “tolerance range”). In some embodiments, a neural network may include multiple memory check layers. Accordingly, in such embodiments, generating 502 the signature and comparing 504 the signature to the memory lookup table may be performed at each memory check layer.

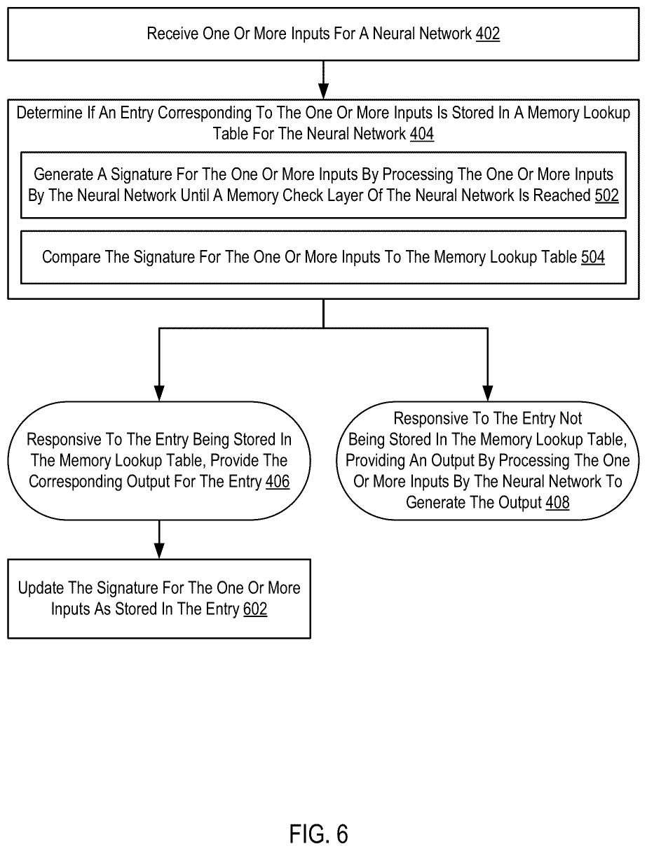

For further explanation, FIG. 6 sets forth a flowchart of an example method of memory recall for neural networks in accordance with some embodiments of the present disclosure. The method of FIG. 6 is similar to FIG. 5 in that the method of FIG. 6 also includes: receiving 402 one or more inputs for a neural network; determining 404 if an entry corresponding to the one or more inputs is stored in a memory lookup table for the neural network, including: generating 404 a signature for the one or more inputs by processing the one or more inputs by the neural network until a memory check layer of the neural network is reached; and comparing 504 the signature for the one or more inputs to the memory lookup table; providing 406, responsive to the entry being stored in the memory lookup table, the corresponding output for the entry; and providing 408, responsive to the entry not being stored in the memory lookup table, an output by processing the one or more inputs by the neural network to generate the output.

The method of FIG. 6 differs from FIG. 5 in that the method of FIG. 6 also includes updating 602 the signature for the one or more inputs as stored in the entry. In some embodiments, where one or more values of input signatures (e.g., for a single matching input or multiple matching inputs over time) approach the tolerance range bounds for the entry signature, one or more values of the entry signature may be shifted. For example, the neural network may be drifting, causing the input signatures to approach the tolerance range bounds for the entry signature, but the neural network may still provide high-confidence output for these inputs. Accordingly, one or more values of the entry signature may be shifted to prevent future input signatures from falling outside the tolerance range and preventing an output from being loaded from the memory lookup table.

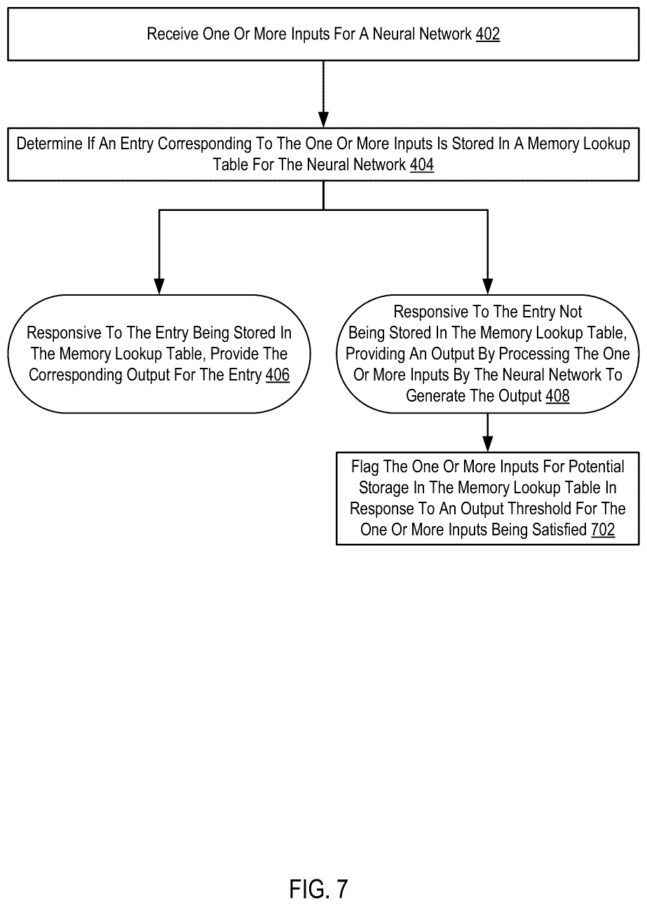

For further explanation, FIG. 7 sets forth a flowchart of an example method of memory recall for neural networks in accordance with some embodiments of the present disclosure. The method of FIG. 7 is similar to FIG. 4 in that the method of FIG. 7 also includes: receiving 402 one or more inputs for a neural network; determining 404 if an entry corresponding to the one or more inputs is stored in a memory lookup table for the neural network; providing 406, responsive to the entry being stored in the memory lookup table, the corresponding output for the entry; and providing 408, responsive to the entry not being stored in the memory lookup table, an output by processing the one or more inputs by the neural network to generate the output.

The method of FIG. 7 differs from FIG. 4 in that the method of FIG. 7 also includes flagging 702 the one or more inputs for potential storage in the memory lookup table in response to an output threshold for the one or more inputs being satisfied. The output threshold is satisfied where the confidence level of the output for the one or more inputs exceeds some threshold (e.g., ninety-eight-percent confidence or greater). In some embodiments, the output threshold may be satisfied where the output confidence level is exceeded for a threshold number of iterations (e.g., N outputs for N instances of the received one or more inputs having confidence levels above the output threshold) or a threshold amount of time (e.g., outputs for the received instances of the one or more instances having confidence above the output threshold for at least one month).

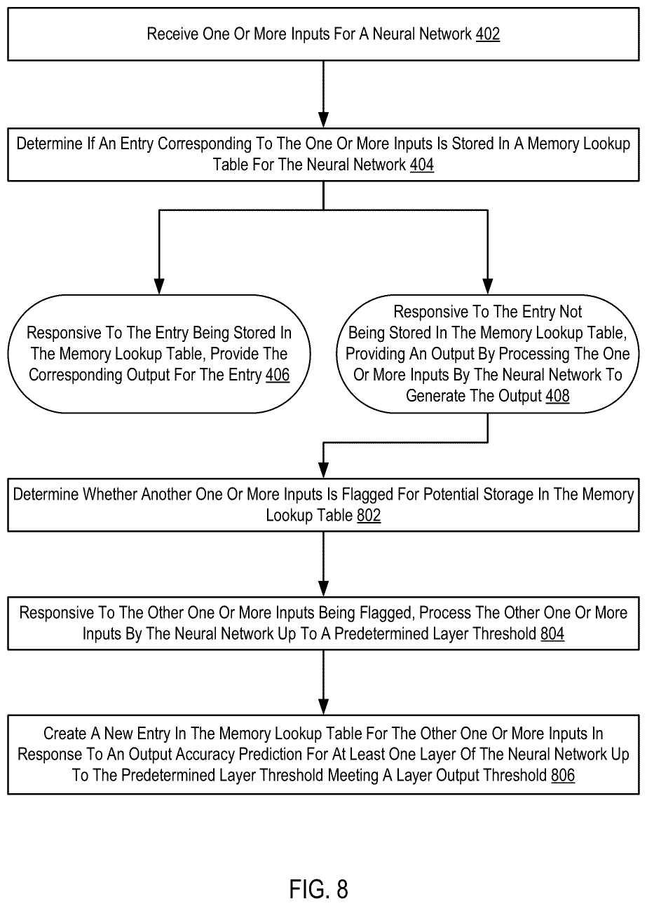

For further explanation, FIG. 8 sets forth a flowchart of an example method of memory recall for neural networks in accordance with some embodiments of the present disclosure. The method of FIG. 8 is similar to FIG. 4 in that the method of FIG. 8 also includes: receiving 402 one or more inputs for a neural network; determining 404 if an entry corresponding to the one or more inputs is stored in a memory lookup table for the neural network; providing 406, responsive to the entry being stored in the memory lookup table, the corresponding output for the entry; and providing 408, responsive to the entry not being stored in the memory lookup table, an output by processing the one or more inputs by the neural network to generate the output.

The method of FIG. 8 differs from FIG. 4 in that the method of FIG. 8 also includes determining 802 whether another one or more inputs is flagged for potential storage in the memory lookup table. The other one or more inputs may include other inputs provided to the neural network for processing. Accordingly, in some embodiments, determining 802 whether the other one or more inputs is flagged for potential storage in the memory lookup table may be performed prior to any processing by the neural network, such as processing the other one or more inputs up to a memory check layer in order to generate a signature. In some embodiments, a table, data structure, and the like may store identifiers or other metadata for input values indicated as being flagged. Accordingly, such a table or data structure may be accessed to determine 802 if the other one or more inputs are flagged.

The method of FIG. 8 also includes processing 804, responsive to the other one or more inputs being flagged, the other one or more inputs by the neural network up to a predetermined layer threshold. In some embodiments, the layer threshold may be a layer where it may be no longer computationally beneficial to query the memory lookup table instead of fully process the other one or more inputs using the neural network. In other words, the layer threshold may be a layer where the computational burden of querying the memory lookup table exceeds the computational burden of processing the other one or more inputs using the remaining layers. In some embodiments, the layer threshold may include a layer where a check layer has been added. In some embodiments, the layer threshold may be a layer after some other check layer to allow for moving the check layer or adding new check layers to the neural network. In some embodiments, the layer threshold may be after the final layer of the neural network such that the other one or more inputs are fully processed.

The method of FIG. 8 also includes creating 806 a new entry in the lookup table for the other one or more inputs in response to an output accuracy prediction for at least one layer of the neural network up to the predetermined layer threshold meeting a layer output threshold. Here, the layer output threshold is met if the output accuracy prediction for at least one layer exceeds some threshold. In some embodiments, this threshold may be different (e.g., greater than or lower) than the threshold described above initially used to flag the other one or more inputs. In some embodiments, this threshold may be configured based on particular design or engineering considerations.

In some embodiments, creating 806 the new entry in the memory lookup table may also be performed in response to a sequence threshold being achieved for the other one or more inputs. For example, each time a particular flagged input is received and its layer output threshold met, an entry may be created, or a count for an existing entry updated, in a temporary table. Thus, when the count for the entry in the temporary table for the other one or more inputs meets the sequence threshold, the entry for the other one or more inputs may be created 806 as a new entry in the memory lookup table. The new entry in the memory lookup table stores an output for the flagged inputs that may be retrieved from the memory lookup table when the input is subsequently encountered by the neural network. In some embodiments, as the inputs have been processed by the neural network up to a memory check layer, this output may be generated by stopping processing of the neural network or skipping layers up to the output layer. In some embodiments, an output may be stored in the flag table when the input is initially flagged. That output in the flag table entry may be loaded and stored in the new entry of the memory lookup table. In some embodiments, where a count was increased only in response to the output from a sequence matching the output from running through the entire neural network, the output generated by running the inputs through the entire neural network may be used in the new memory lookup table entry. The flag for the one or more inputs indicating that they may be potentially stored in the memory lookup table may be removed.

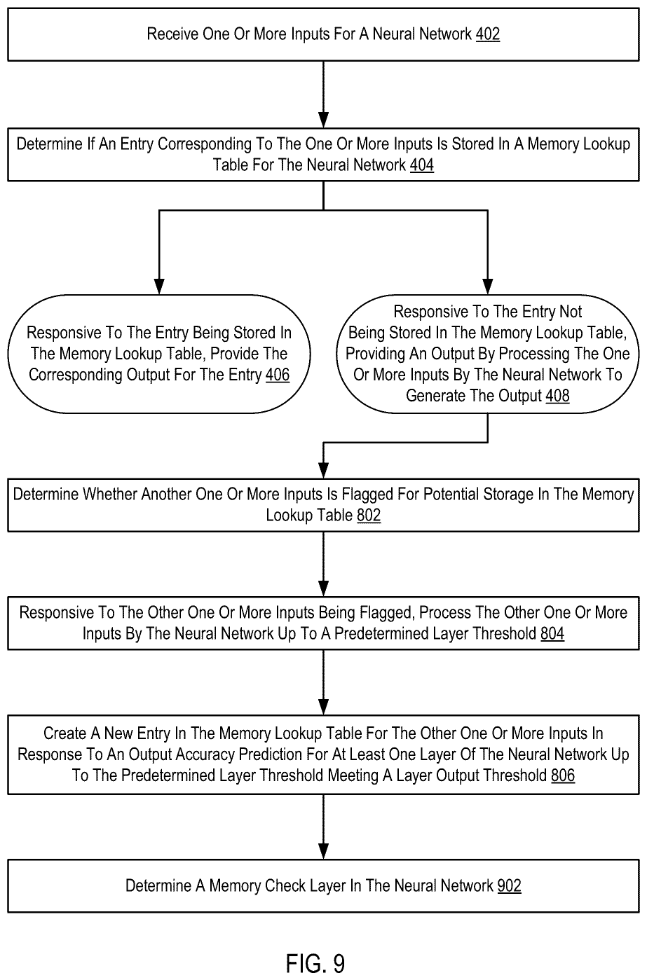

For further explanation, FIG. 9 sets forth a flowchart of an example method of memory recall for neural networks in accordance with some embodiments of the present disclosure. The method of FIG. 9 is similar to FIG. 8 in that the method of FIG. 9 also includes: receiving 402 one or more inputs for a neural network; determining 404 if an entry corresponding to the one or more inputs is stored in a memory lookup table for the neural network; providing 406, responsive to the entry being stored in the memory lookup table, the corresponding output for the entry; and providing 408, responsive to the entry not being stored in the memory lookup table, an output by processing the one or more inputs by the neural network to generate the output; determining 802 whether another one or more inputs is flagged for potential storage in the memory lookup table; processing 804, responsive to the other one or more inputs being flagged, the other one or more inputs by the neural network up to a predetermined layer threshold; and creating 806 a new entry in the lookup table for the other one or more inputs in response to an output accuracy prediction for at least one layer of the neural network up to the predetermined layer threshold meeting a layer output threshold.

The method of FIG. 9 also includes determining 902 a memory check layer in the neural network. This may include determining whether a memory check layer should be added or whether an existing memory check layer should be moved. In some embodiments, a current version of the neural network up to where the layer output threshold was achieved (e.g., the layers of the neural network that processed the previously flagged other one or more inputs) may be saved. In some embodiments, where the layer output threshold was achieved at a layer after current memory check layers, an additional layer can be added or an existing layer may be shifted. In some embodiments, where the layer output threshold was achieved at a layer before current memory check layers an additional layer can be added or the signature can be tracked up to the current memory check layer even if not required for the specific signature. In some embodiments, memory check layers may be shifted based on an analysis of the entries within the memory lookup table. For example, memory check layers may be shifted or established at the highest layer in a memory lookup table entry signature, an average layer at which a memory lookup table entry signature ends, and the like.

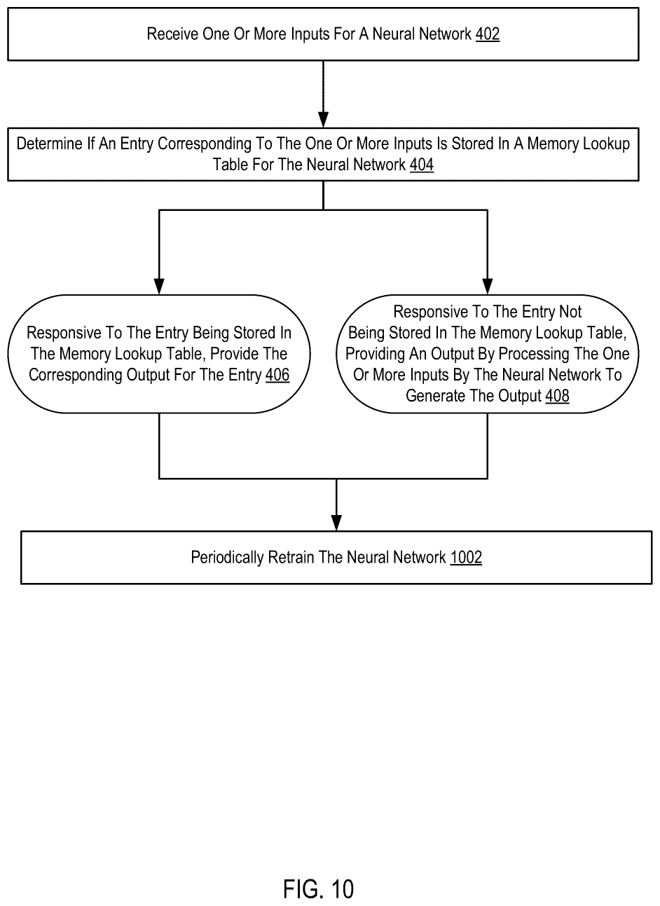

For further explanation, FIG. 10 sets forth a flowchart of an example method of memory recall for neural networks in accordance with some embodiments of the present disclosure. The method of FIG. 10 is similar to FIG. 4 in that the method of FIG. 10 also includes: receiving 402 one or more inputs for a neural network; determining 404 if an entry corresponding to the one or more inputs is stored in a memory lookup table for the neural network; providing 406, responsive to the entry being stored in the memory lookup table, the corresponding output for the entry; and providing 408, responsive to the entry not being stored in the memory lookup table, an output by processing the one or more inputs by the neural network to generate the output.

The method of FIG. 10 differs from FIG. 4 in that the method of FIG. 10 also includes periodically retraining 1002 the neural network. For example, in some embodiments, the neural network may be retrained each time after an output is generated by the neural network using some input. In some embodiments, the neural network may be retrained every N iterations of the neural network (e.g., after producing N outputs by the neural network), at a predefined interval using input and output generated during that interval, or in response to other conditions as can be appreciated. The neural network may be retrained using supervised learning, unsupervised learning, semi-supervised learning, or any other training approach as can be appreciated.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving one or more inputs for a neural network;
determining if an entry corresponding to the one or more inputs is stored in a memory lookup table for the neural network, wherein the memory lookup table comprises a plurality of entries each associating a respective neural network input with a corresponding output generated by a version of the neural network;
responsive to the entry being stored in the memory lookup table, providing the corresponding output for the entry; and
responsive to the entry not being stored in the memory lookup table, providing an output by processing the one or more inputs by the neural network to generate the output.

2. The method of claim 1, wherein determining if an entry corresponding to the one or more inputs is stored in the memory lookup table comprises:
generating a signature for the one or more inputs by processing the one or more inputs by the neural network until a memory check layer of the neural network is reached; and
comparing the signature for the one or more inputs to the memory lookup table.

3. The method of claim 2, further comprising updating the signature for the one or more inputs as stored in the entry.

4. The method of claim 1, further comprising flagging the one or more inputs for potential storage in the memory lookup table in response to an output threshold for the one or more inputs being satisfied.

5. The method of claim 2, wherein comparing the signature for the one or more inputs to the memory lookup table is based on a tolerance range.

6. The method of claim 1, further comprising:
determining whether another one or more inputs is flagged for potential storage in the memory lookup table;
responsive to the other one or more inputs being flagged, processing the other one or more inputs by the neural network up to a predetermined layer threshold; and
creating a new entry in the memory lookup table for the other one or more inputs in response to an output accuracy prediction for at least one layer of the neural network up to the predetermined layer threshold meeting a layer output threshold.

7. The method of claim 6, wherein creating the new entry in the memory lookup table is further performed in response to a count associated with the one or more inputs meeting a count threshold.

8. The method of claim 6, further comprising determining a memory check layer in the neural network.

9. The method of claim 1, further comprising periodically retraining the neural network.

10. An apparatus comprising:
a processing device; and
memory operatively coupled to the processing device, wherein the memory stores computer program instructions that, when executed, cause the processing device to:
receive one or more inputs for a neural network;
determine if an entry corresponding to the one or more inputs is stored in a memory lookup table for the neural network, wherein the memory lookup table comprises a plurality of entries each associating a respective neural network input with a corresponding output generated by a version of the neural network;
responsive to the entry being stored in the memory lookup table, provide the corresponding output for the entry; and
responsive to the entry not being stored in the memory lookup table, provide an output by processing the one or more inputs by the neural network to generate the output.

11. The apparatus of claim 10, wherein determining if an entry corresponding to the one or more inputs is stored in the memory lookup table comprises:
generating a signature for the one or more inputs by processing the one or more inputs by the neural network until a memory check layer of the neural network is reached; and
comparing the signature for the one or more inputs to the memory lookup table.

12. The apparatus of claim 11, wherein the computer program instructions, when executed, further cause the processing device to update the signature for the one or more inputs as stored in the entry.

13. The apparatus of claim 12, wherein the computer program instructions, when executed, further cause the processing device to flag the one or more inputs for potential storage in the memory lookup table in response to an output threshold for the one or more inputs being satisfied.

14. The apparatus of claim 11, wherein comparing the signature for the one or more inputs to the memory lookup table is based on a tolerance range.

15. The apparatus of claim 10, wherein the computer program instructions, when executed, further cause the processing device to:
determine whether another one or more inputs is flagged for potential storage in the memory lookup table;
responsive to the other one or more inputs being flagged, process the other one or more inputs by the neural network up to a predetermined layer threshold; and
create a new entry in the memory lookup table for the other one or more inputs in response to an output accuracy prediction for at least one layer of the neural network up to the predetermined layer threshold meeting a layer output threshold.

16. The apparatus of claim 15, wherein creating the new entry in the memory lookup table is further performed in response to a count associated with the one or more inputs meeting a count threshold.

17. The apparatus of claim 15, wherein the computer program instructions, when executed, further cause the processing device to determine a memory check layer in the neural network.

18. The apparatus of claim 10, wherein the computer program instructions, when executed, further cause the processing device to periodically retrain the neural network.

19. A computer program product comprising a computer readable storage medium, wherein the computer readable storage medium comprises computer program instructions that, when executed:
receive one or more inputs for a neural network;
determine if an entry corresponding to the one or more inputs is stored in a memory lookup table for the neural network, wherein the memory lookup table comprises a plurality of entries each associating a respective neural network input with a corresponding output generated by a version of the neural network;
responsive to the entry being stored in the memory lookup table, provide the corresponding output for the entry; and
responsive to the entry not being stored in the memory lookup table, provide an output by processing the one or more inputs by the neural network to generate the output.

20. The computer program product of claim 19, wherein determining if an entry corresponding to the one or more inputs is stored in the memory lookup table comprises:
generating a signature for the one or more inputs by processing the one or more inputs by the neural network until a memory check layer of the neural network is reached; and
comparing the signature for the one or more inputs to the memory lookup table.

21. The computer program product of claim 20, wherein the computer program instructions, when executed, update the signature for the one or more inputs as stored in the entry.

22. The computer program product of claim 21, wherein the computer program instructions, when executed, flag the one or more inputs for potential storage in the memory lookup table in response to an output threshold for the one or more inputs being satisfied.

23. The computer program product of claim 20, wherein comparing the signature for the one or more inputs to the memory lookup table is based on a tolerance range.

24. The computer program product of claim 19, wherein the computer program instructions, when executed:
determine whether another one or more inputs is flagged for potential storage in the memory lookup table;
responsive to the other one or more inputs being flagged, process the other one or more inputs by the neural network up to a predetermined layer threshold; and
create a new entry in the memory lookup table for the other one or more inputs in response to an output accuracy prediction for at least one layer of the neural network up to the predetermined layer threshold meeting a layer output threshold.

25. The computer program product of claim 24, wherein creating the new entry in the memory lookup table is further performed in response to a count associated with the one or more inputs meeting a count threshold.
